(19) United States
(12) Patent Application Publication
(10) Pub. No.: US 2015/0124070 A1
(43) Pub. Date: May 7, 2015

(54) EYEPIECE ADAPTER FOR RECORDING AND TRANSMITTING IMAGES

(71) Applicants: Srinivas Dutt, Land O Lakes, FL (US); Niroo Dutt, Land O Lakes, FL (US); Anisha Dutt, Land O Lakes, FL (US); Nikhil Dutt, Land O Lakes, FL (US)

(72) Inventors: Srinivas Dutt, Land O Lakes, FL (US); Niroo Dutt, Land O Lakes, FL (US); Anisha Dutt, Land O Lakes, FL (US); Nikhil Dutt, Land O Lakes, FL (US)

(21) Appl. No.: 14/530,886

(22) Filed: Nov. 3, 2014

Related U.S. Application Data
(60) Provisional application No. 61/899,014, filed on Nov. 1, 2013.

(51) Int. Cl. H04N 7/18; H04N 5/225; G02B 25/00

(52) U.S. Cl. CPC H04N 7/183; G02B 25/001; H04N 5/2252
USPC 348/78

(57) ABSTRACT

An eyepiece adapter is provided. The adapter includes a tubular body having a first end, a second end, and a light path therethrough. The second end is releasably attachable to an eyepiece shaft of a viewing device. An image module may be attached to the tubular body. The image module may at least include an image sensor operable to receive and record a light image. The present invention may further include a beam splitter disposed within the tubular body. The beam splitter is positioned to direct a portion of the light image towards the first end of the tubular body and a portion of the light image towards the image sensor.

### CROSS-REFERENCE TO RELATED APPLICATION

This application claims the benefit of priority of U.S. provisional application No. 61/899,014, filed Nov. 1, 2013, the contents of which are herein incorporated by reference.

### BACKGROUND OF THE INVENTION

The present invention relates to recording and transmitting images and, more particularly, to an eyepiece adapter attachable to a scope for recording and transmitting images.

A scope may refer to many different devices or viewing instruments, constructed for many different purposes. A microscope is an instrument used to see objects that are too small for the naked eye. A telescope is an instrument that aids in the observation of remote objects by collecting electromagnetic radiation, such as visible light. Binoculars are a pair of identical or mirror-symmetrical telescopes mounted side-by-side and aligned to point accurately in the same direction, allowing the viewer to use both eyes when viewing distant objects. Currently, using the above mentioned devices, a viewer may observe through the scopes. However, the user may not record the viewed images or remotely observe the images.

As can be seen, there is a need for a modular device that changes scopes into recording and transmitting devices.

### SUMMARY OF THE INVENTION

In one aspect of the present invention, an eyepiece adapter comprises: a tubular body comprising a first end, a second end, and a light path therethrough, wherein the second end is releasably attachable to an eyepiece shaft of a viewing device; an image module comprising an image sensor operable to receive a light image; and a beam splitter disposed within the tubular body and positioned to direct a portion of the light image towards the first end of the tubular body and a portion of the light image towards the image sensor.

In another aspect of the present invention, a method of recording a light image of a viewing device comprises: providing an eyepiece adapter comprising: a first end, a second end, and a light path therethrough; an image recording device comprising an image sensor operable to receive and record a light image; and a beam splitter disposed within the eyepiece adapter and positioned to direct a portion of the light image towards the first end of the tubular body and a portion of the light image towards the image sensor; removing a scope eyepiece from an eyepiece shaft of the viewing device; and slidably engaging the second end of the eyepiece adapter within the eyepiece shaft.

These and other features, aspects and advantages of the present invention will become better understood with reference to the following drawings, description and claims.

### BRIEF DESCRIPTION OF THE DRAWINGS

FIG. 1 is a perspective schematic view of an embodiment of the present invention shown in use;

FIG. 2 is a perspective view of an embodiment of the present invention;

FIG. 3 is a front view of an embodiment of the present invention;

FIG. 4 is an exploded view an embodiment of the present invention; and

FIG. 5 is a section view an embodiment of the present invention along line 5-5 in FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes an eyepiece adapter for simultaneous, direct and remote scope viewing, processing and transmitting of images. The present invention is compact and easy to use with viewing devices, such as scopes. The present invention may be used with microscopes, telescopes, medical scopes, surgical scopes, binoculars, monoculars, and the like. Any scope can be converted into an imaging processing and transmitting device with the present invention. The present invention may be used with any device that receives electromagnetic radiation, resulting in captured images.

In a binocular scope, using two imaging eyepiece adapters would allow binocular, remote, stereo imaging. The imaging may be enhanced with software and hardware configurations. A monocular image could be modified to create 3D, stereo images. Images could be processed or modified to produce desired effects.

The eyepiece and image digital processing module could be reconfigured to exchange positions as illustrated in the Figures, with the eyepiece receiving the image from the beam splitter and the image processing module receiving the direct image.

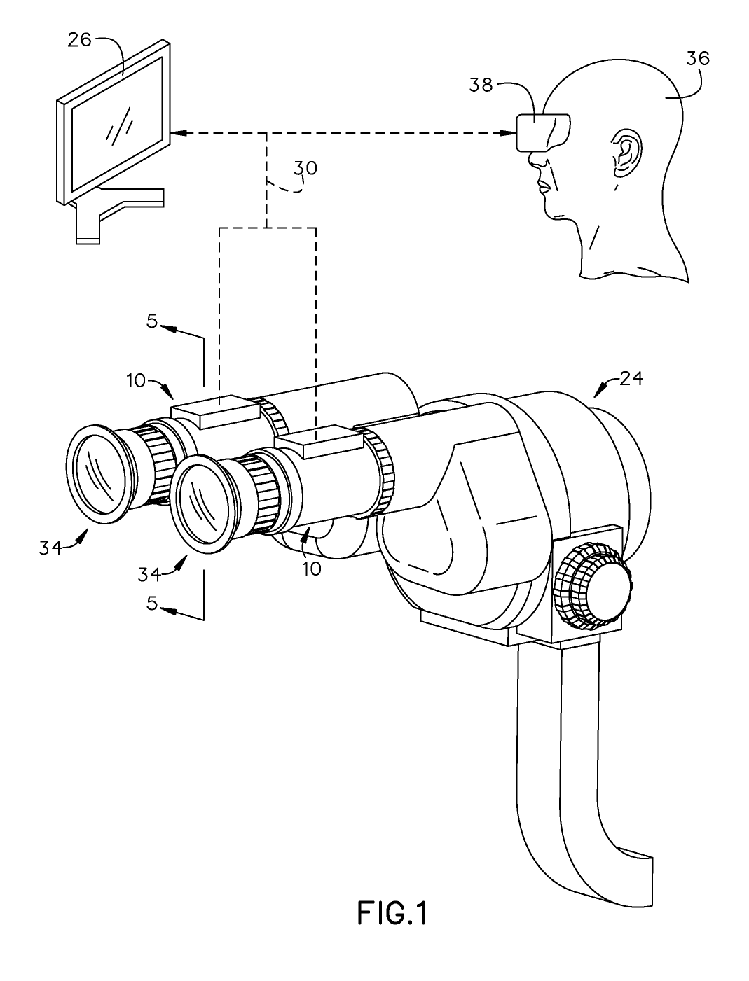

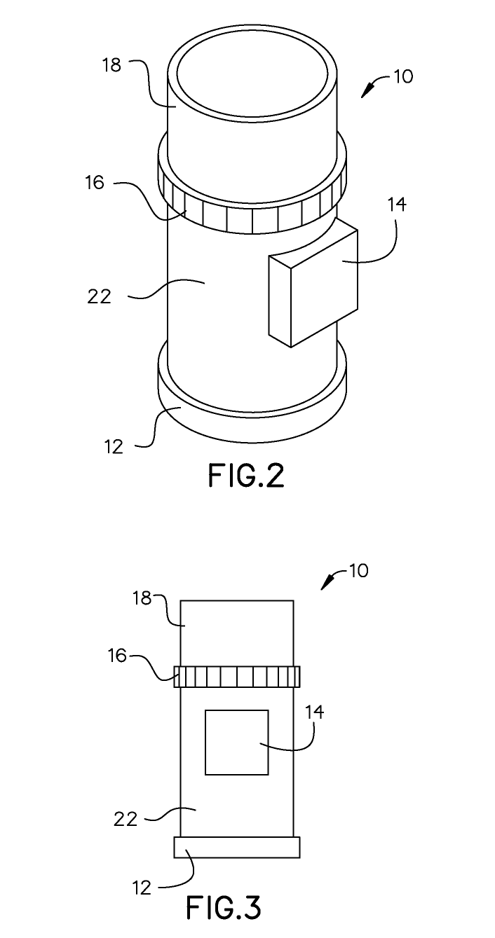

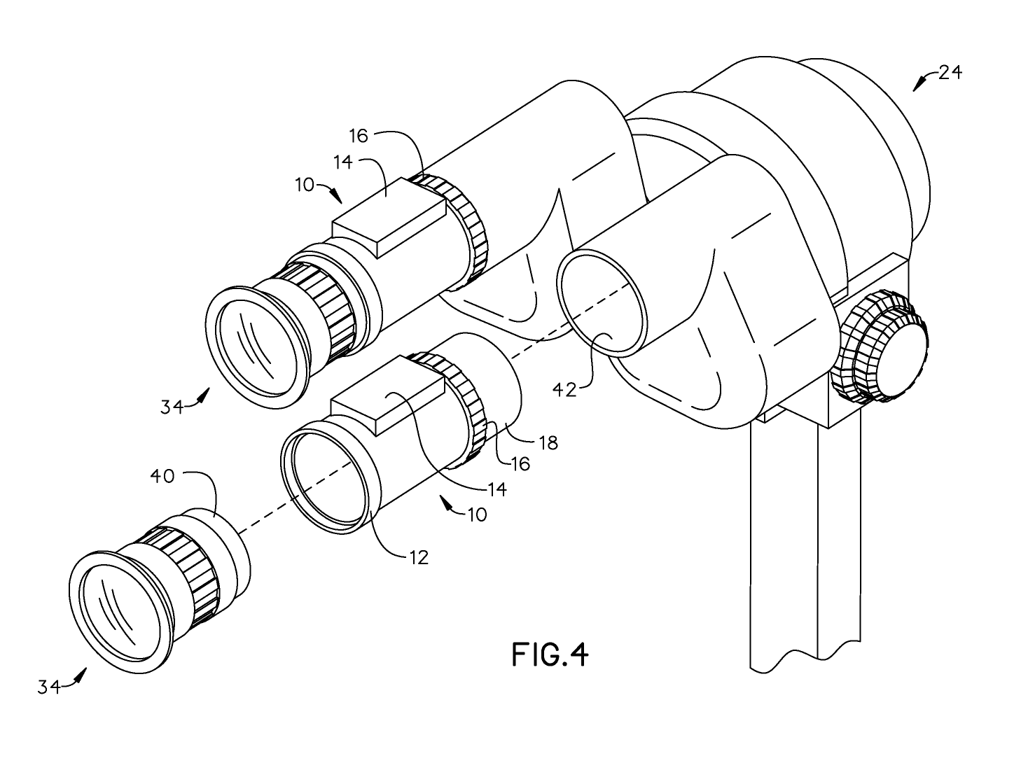

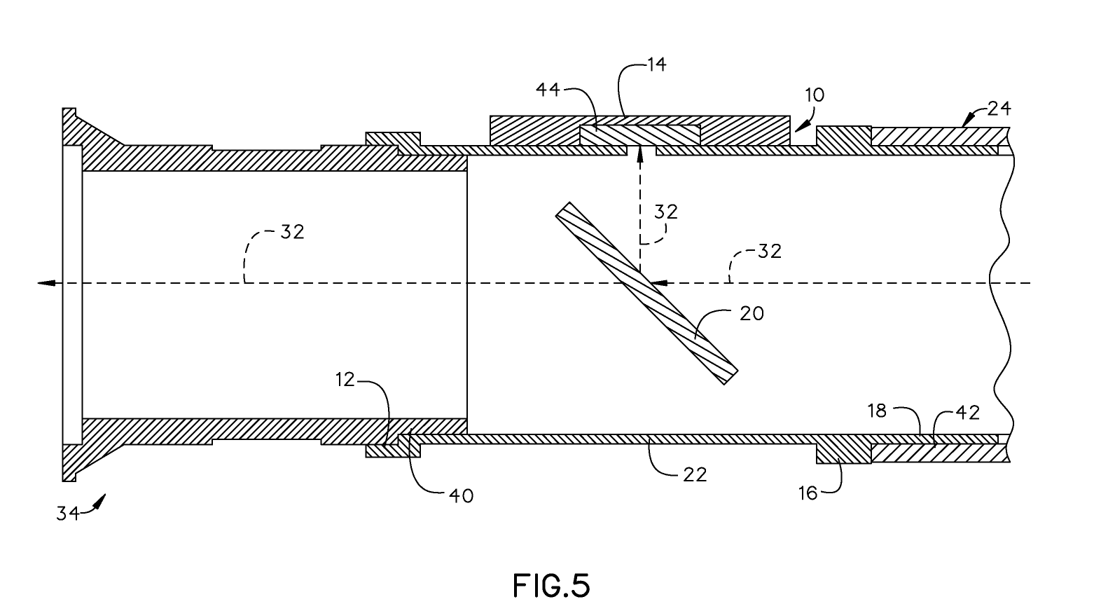

Referring to FIGS. 1 through 5, the present invention includes an eyepiece adapter 10. The adapter 10 includes a tubular body 22 having a first end, a second end, and a light path therethrough. The second end is releasably attachable to an eyepiece shaft 42 of a viewing device 24. An image module 14 may be attached to the tubular body 22. The image module 14 may include an image sensor 44 operable to receive and record a light image 32. The present invention may further include a beam splitter 20 disposed within the tubular body 22. The beam splitter 20 is positioned to direct a portion of the light image 32 towards the first end of the tubular body 22 and a portion of the light image 32 towards the image sensor 44.

The beam splitter 20 of the present invention may vary and may include translucent, prismatic, or reflective materials. The beam splitter 20 may be fixed within the tubular body 22 or be movable from a slot within the tubular body 22. As illustrated in the drawings, the beam splitter 20 is a prism that is oriented at an angle to direct the light image 32 in two directions. In certain embodiments, a combination of prisms and mirrors can be employed to control light movement.

The eyepiece adaptor 10 of the present invention is used as an add-on to existing viewing devices 24, such as scopes. As illustrated in the Figures, the second end of the adaptor 10 may include an extension tube 18. The extension tube 18 may slidably engage and fit within the eyepiece shaft 42 of the viewing device 24. Therefore, the eyepiece adaptor 20 releasably secures to the viewing device 24. The extension tube 18 may be made in different sizes and shapes to conform to different sized viewing devices 24.

A scope eyepiece 34 may be attached to the first end of the adaptor 10. In certain embodiments, the scope eyepiece 34 may be fixed to the first end of the adaptor 10. However, in certain embodiments, the scope eyepiece 34 of the viewing device 24 may be used. In such embodiments, the first end of the adaptor 10 may include an insertion flange 12. The insertion flange 12 may be formed to receive and secure an outer rim 40 of the scope eyepiece 34 of the viewing device 24. In certain embodiments, the scope eyepiece 34 may be capped to only allow viewing through the image module 14.

In certain embodiments, the present invention may include an internal lens within the tubular body 22. The eyepiece adapter 10 may further include a focus ring 16 operable to adjust the internal lens and focus the light image 32 onto the beam splitter 20. In certain embodiments, a focus ring 16 may adjust the length of the extension tube 18 to focus the light image 32 onto the beam splitter 20.

The image module 14 may include a recorder, a transmitter or a combination thereof. Therefore, the image module 14 may record the light image 32 and transmit the light image 32 to a remote viewing location. The recorder may include memory that saves the recording of the light image 32. When the present invention utilizes a transmitter, a remote monitor 26, a viewing headset 38 or a combination thereof may be used to view the light image 32. As illustrated in FIG. 1, the viewing headset 38 may be secured to a user 36. The transmitter provides a live feed to at least one of the viewing headset 38 and the monitor 26. Images may be transmitted from the image module 14 using wired or wireless modalities 30 such as Wi-Fi and Bluetooth®.

A modified version of the present invention could be employed along any transmission of electromagnetic energy such as fiber optic cables and electric lines, and allow data capture and analysis. The image digital processing module could be specialized to capture a particular signal. If multiple devices were placed in serial order, it would allow simultaneous capture of different information from the same source. The image digital processing module can vary depending upon the requirements of resolution, function, and complexity. It can be powered by rechargeable battery or electrical connection. The imaging digital processing sensor could be of varying modalities, resolutions, and sizes.

A method of using the present invention may include the following. The eyepiece of a scope is removed from its shaft. The extension tube of the present invention is inserted into the shaft of the scope. The eyepiece is placed in the eyepiece insertion flange. The apparatus is powered either with battery or electrical current. Light images from the scope enter the extension tube and contact the lenses of the focusing ring, which further focuses the light rays. Then the light contacts the beam splitter, where one of the split images is sent to the eyepiece insertion tube and then through the eyepiece, giving the direct view. Additional focus for the observer can be obtained with the focus ring on the eyepiece. The beam splitter sends the other split image to the image digital processing module. The image is received, modified, stored, and transmitted. The transmission can be wired or wireless. The images can be received and viewed on a display. If the scope has two eyepieces, this apparatus can be applied to both shafts and allow remote, binocular, 3D viewing on configured display systems. Images could be simultaneously transmitted to each side of virtual reality glasses or digital goggles to create a 3D virtual image. If there is only one eyepiece, a monocular image could be obtained and transmitted. The monocular image could be duplicated and offset, creating a pseudo-binocular image. The images can be further processed, recorded, annotated, modified, and communicated.

It should be understood, of course, that the foregoing relates to exemplary embodiments of the invention and that modifications may be made without departing from the spirit and scope of the invention as set forth in the following claims.

What is claimed is:

1. An eyepiece adapter comprising:
a tubular body comprising a first end, a second end, and a light path therethrough, wherein the second end is releasably attachable to an eyepiece shaft of a viewing device;
an image module comprising an image sensor operable to receive a light image; and
a beam splitter disposed within the tubular body and positioned to direct a portion of the light image towards the first end of the tubular body and a portion of the light image towards the image sensor.

2. The eyepiece adapter of claim 1, wherein the second end comprises an extension tube that mates with the eyepiece shaft of the viewing device.

3. The eyepiece adapter of claim 1, wherein the first end comprises a scope eyepiece.

4. The eyepiece adapter of claim 3, wherein the first end comprises an insertion flange formed to receive and secure the scope eyepiece of the viewing device.

5. The eyepiece adapter of claim 1, further comprising a focus ring operable to adjust a focus of the light image onto the beam splitter.

6. The eyepiece adapter of claim 1, wherein the image module further comprises at least one of a recorder and a transmitter.

7. The eyepiece adapter of claim 6, further comprising at least one of a viewing headset and a monitor electrically connected to the transmitter.

8. The eyepiece adapter of claim 7, wherein the electrical connection is at least one of a wireless connection and a wired connection.

9. The eyepiece adapter of claim 6, wherein the transmitter provides a live feed to at least one of the viewing headset and the monitor.

10. The eyepiece adapter of claim 1, wherein the beam splitter is at least one of a prism and a reflector.

11. A method of recording a light image of a viewing device comprising:
providing an eyepiece adapter comprising:
a first end, a second end, and a light path therethrough;
an image recording device comprising an image sensor operable to receive and record a light image; and
a beam splitter disposed within the eyepiece adapter and positioned to direct a portion of the light image towards the first end of the tubular body and a portion of the light image towards the image sensor;
removing a scope eyepiece from an eyepiece shaft of the viewing device; and
slidably engaging the second end of the eyepiece adapter within the eyepiece shaft.

12. The method of claim 11, further comprising the step of slidably engaging the scope eyepiece to the first end of the eyepiece adapter.
